(19) United States
(12) Patent Application Publication
(10) Pub. No.: US 2008/0062313 A1
(43) Pub. Date: Mar. 13, 2008

(54) Apparatus for Processing Video Signals

(75) Inventor: Tao You, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,361

(22) PCT Filed: Aug. 10, 2005
(86) PCT No.: PCT/IB05/52649

§ 371 Date: Feb. 7, 2007

(30) Foreign Application Priority Data
Aug. 12, 2004 (EP) 04103897.7

(51) Int. Cl. H04N 7/00

(52) U.S. Cl. 348/468

(57) ABSTRACT

The apparatus comprises processing circuitry for processing video signals and a memory (10) for storing information related to the video signal in a first operation mode. The apparatus further comprises a radio receiver (20) or other audio reception circuitry (1,5) for receiving an audio signal, and a memory controller (24) for arranging storing and retrieving of the received audio signal in the memory (10). To increase the value of the apparatus for the user, audio signals may be stored into and retrieved from the memory (10) during a semi-standby mode when the apparatus is not used for processing video signals.

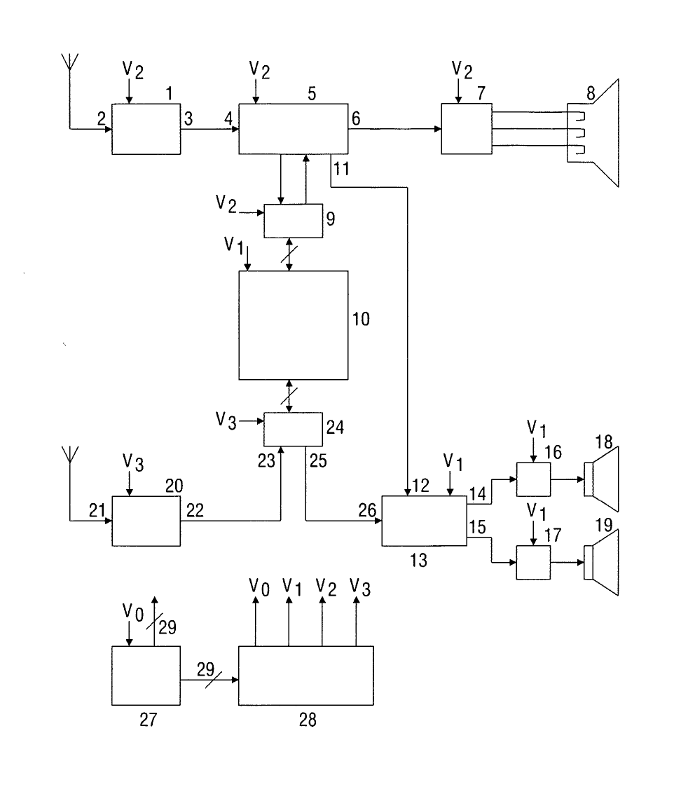

The invention relates to an apparatus for processing video signals, the apparatus comprising a video memory.

An example of such kind of apparatus is a “100 Hz” television receiver. The TV-signal having a 50 Hz frame frequency is converted to a signal with 100 Hz frame frequency, so that a much more quiet picture without the disturbing area-flicker is displayed on the screen of the picture tube or on the flat screen display. In one example, each full frame of the incoming TV-signal is stored into a video memory and subsequently the video memory is read out twice so that for each received TV-frame two frames are available for display on the screen.

In addition to the memory that is required for doubling the frame rate, the TV-receiver often comprises additional memory for storing teletext pages. Teletext pages are text pages that are transmitted one after the other during the flyback periods between two successive frames of video signal. When there are many different teletext pages transmitted, the user often has to wait a long time until the required teletext page is received. The accession time to a specific desired teletext page can be highly decreased by storing a (large) number of teletext pages in advance into a memory. The user can then quickly read out the required teletext information from the memory upon request. Currently in Philips TV-receivers a 4 MB SDRAM memory chip is used, 2 MB of which serves the video processing and another 2 MB serve the storage of teletext information. In this application the whole memory will be referred to with the term: “memory”. It may be expected that in the future the size of this memory will be further increased to store more teletext pages and/or to enable more sophisticated video processing especially in the flat screen domain such as LCD-TV or plasma TV.

It is an object of the invention to substantially increase for the user the value of the television apparatus without substantially increasing the cost of the apparatus. The invention is defined by the independent claims. The dependent claims define advantageous embodiments.

In a first operation mode the memory is used for processing of the video signals, for example for enhancing the video signal or converting the signal into another format. Examples of processing are frame rate doubling as used in 100 Hz television receivers, format conversion as usually done by scalers, and realizing display of more than one video signal simultaneously (for example realizing a picture-in-picture feature).

The invention may e.g. be used in a television apparatus with built-in radio receiver. In another operation mode, for example a semi-standby mode, wherein no video is to be processed, the user may tune the radio receiver to a desired channel and set the time period that desired audio signals from this channel are to be stored. The desired signals may be, for example, news flashes or stock information or a favorite music program. During the semi-standby mode those desired signals are then stored into the memory and the user can listen to the signals at any time and as many times he wants.

The invention may also be used to store an audio signal of a television program, an audio signal obtained from an external device coupled to the television apparatus, or an audio signal obtained via a network connection, for example via an internet connection. When turning on the apparatus, for example with a dedicated button on the apparatus or on a remote control unit of the apparatus, firstly the audio signal is retrieved. The apparatus may also be a television tuner, an audio/video amplifier or receiver, a satellite tuner, or any other apparatus which includes processing of information related to video signals.

Usually in television apparatus there are three power modes:
“power off” in which the apparatus is completely switched off;
“power on” in which all the television function are powered, such as television tuner, video and teletext processing, video memory, audio processing, video and audio output stages, synchronization and deflection stages and the control unit;
“standby mode” in which only the control unit and (part of) the power unit is “on” and all other units are “off”.

In an embodiment, in the “semi-standby” mode, next to the control unit with the running software, the radio tuner, the audio processing and audio output stages and the video memory are powered. All the video processing circuitry and/or functions that are specifically intended for the display on the TV-screen are switched off to save power.

It has to be remarked that the television receiver need not necessarily include a tuner and/or IF-stage for radio signals. The receiver can also be used with an external radio receiver, provided of course that the television receiver has an audio input for connecting such external radio receiver thereto. Preferably the external radio receiver is able to exchange control signals with the television receiver.

A presently usual memory of 4 MB, used in a first operation mode for storing video signals, can store a two-channel radio program signal of about 7 minutes duration. If a longer duration of the radio program is desired the radio program signal is preferably stored in the memory in compressed form, e.g. in MP3 or WMA format. Alternatively or additionally, the radio program signal can be stored in monaural (one-channel) form.

The invention will be described with reference to the accompanying FIGURE, which shows a schematic diagram of an example of an apparatus in accordance with the invention.

The television apparatus of this FIGURE comprises a television tuning and video-IF unit 1 with an antenna input 2 and an output terminal 3 that is connected to an input terminal 4 of a video processor 5. An output 6 of this video processor 5 supplies video signals to a video output unit 7 that sends red, green and blue video signals to a picture display tube or panel 8. The video processor 5 is coupled through a first memory controller 9 to a memory 10 for storing video signals in a first operation mode. The first memory controller 9 stores video signals from the video processor 5 into the memory 10 and reads the video signals from the memory 10 back to the video processor 5, thereby doubling the frame rate of the video signals. When the video signals processed in the unit 5 are in analog form the first memory controller 9 contains AD and DA converters enabling the storage of the video signals in digital form.

The video processor 5 further has a second output terminal 11 for outputting the audio signal that accompanies the video signal either in multiplex format or de-multiplexed. This audio signal is supplied to an input terminal 12 of an audio processor 13. The audio processor derives from said audio signal left and right audio signals at output terminals 14 and 15 of the audio processor 13. These left and right audio signals are supplied through left and right audio output stages 16 and 17 to left and right loudspeakers 18 and 19, respectively.

The arrangement described so far is standard prior art and needs no further explanation. The arrangement may be modified in many ways without departing from the scope of the invention. For instance the arrangement may contain a teletext decoding function that makes use of the memory 10 to store a plurality of teletext pages.

Additionally, in accordance with an embodiment of the present invention, the television apparatus of the figure is provided with a radio head end 20 for tuning, intermediate frequency amplifying and demodulating radio signals that are received through an antenna input terminal 21. The demodulated audio signals are available at an output terminal 22 of the head end 20 and delivered to an input terminal 23 of a second memory controller 24. This second controller 24 is arranged to store the audio signals from radio head end into the memory 10 in a second operation mode. A second function of the second memory controller 24 is to retrieve the audio signals, stored in the memory 10, to output these signals at an output terminal 25 and to apply these to a second input terminal 26 of the audio processor 12.

The apparatus further comprises a control unit 27 and a power block 28. The control unit receives control commands e.g. from a remote control and controls the respective units of the apparatus, preferably through a digital control bus 29 such as an I²C-bus. The power block 28 delivers a supply voltage V₀ to power the control unit 27, one or more supply voltages V₁ to power the memory 10 and the audio stages 13, 16 and 17, one or more supply voltages V₂ to power the video stages 1, 5, 7 and 9 and one or more supply voltages V₃ to power the radio head end 20 and the second memory controller 24. The power block 28 may be in the “off”-mode in which no supply voltage at all is delivered, in the “stand-by” mode in which only the voltage V₀ is delivered that powers the control unit 27, and in the “on”-mode in which additionally the supply voltages V₁ and V₂ are delivered and wherein the apparatus functions as a usual TV-receiver with operational video chain and audio chain and with the memory 10 operating to increase the frame rate of the video signal. In a “semi-standby”-mode the voltages V₀, V₁ and V₃ are delivered, so that the radio head end 20 is operational, the second controller 24 and the video-memory 10 are operational to store and retrieve the audio signals from the radio head end 20 and the audio channel 13, 16, 17 is operational to play back the audio signals retrieved from the memory 10.

It is remarked that, when the programming of the radio head end, i.e. the channel selection and the setting of the timer for the selection of the desired program and the time period, is done via “On Screen Display”, this programming has to be done prior to the “semi standby” mode, i.e. during the “on” mode when the display by the picture tube or panel 8 is still active.

In the semi-standby mode, delivery of the voltage V₃ supplied to the radio head end 20 may be restricted to the time period of receiving the desired program, while delivery of the voltage V₁ supplied to the audio channel 13, 16, 17 may be restricted to a time period when the audio signals are retrieved from the video-memory 10.

In another embodiment the audio signal as received with the video signal is to be stored into the memory 10. In this case the output terminal 11 is also coupled to an input of the second controller 24 (not shown). In this embodiment the voltage V₂ should be supplied to the tuning and IF unit 1 and the video processor 5, while the audio signal is being stored in the semi-standby mode.

It should be mentioned that the above-described embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Apparatus comprising:
processing circuitry for processing video signals:
a memory (10) for storing in a first operation mode information related to the video signal in order to enhance and /or convert the video signal and/or teletext information;
means (20; 1,5) for receiving an audio signal;
controlling means (24) for arranging storing of said audio signal into the memory (10) in a second operation mode in which second operation mode the processing circuitry does not process video signals; and
means (24, 13) for retrieving the audio signal from the memory (10) in the second operation mode.

2. Apparatus as claimed in claim 1, the controlling means (24) being adapted to arrange storing of said audio signal into the video memory (10) in a compressed and/or monaural format.

3. Apparatus as claimed in claim 1, the receiving means (20; 1,5) comprising a radio receiver (20).

4. Apparatus as claimed in claim 1, the receiving means (20; 1,5) comprising a video processor (5).

5. Apparatus as claimed in claim 1, further comprising a control unit (29) for enabling power to be supplied to the receiving means (20; 1,5), the controlling means (24) and the memory (10) during a time period for storing the audio signal, while power to other units of the apparatus, which are not needed for receiving or controlling or storing of the audio signal, is substantially disabled.

6. Apparatus as claimed in claim 1, further comprising a control unit (29) for enabling power to be supplied to the receiving means (20; 1,5) during a time period for storing the audio signal.

7. A method of processing video signals, the method comprising:
storing in a first operation mode information related to the video signal in order to enhance or convert the video signal and/or teletext information into a memory (10);
receiving an audio signal;
storing said audio signal into the memory (10) in a second operation mode in which circuitry for processing video signals does not process the video signals; and
retrieving the audio signal from the memory (10) in the second operation mode.
